(19) United States
(12) Patent Application Publication
(10) Pub. No.: US 2025/0181418 A1
(43) Pub. Date: Jun. 5, 2025

(54) DESIGNATION OF A SWAP CONTROL SYSTEM IN A GROUP OF PEERS WITHIN A COMPUTING CLUSTER

(71) Applicant: INTERNATIONAL BUSINESS MACHINES CORPORATION, ARMONK, NY (US)

(72) Inventors: TARIQ HANIF, LAGRANGEVILLE, NY (US); TABOR R. POWELSON, POUGHKEEPSIE, NY (US); SCOTT B. COMPTON, HYDE PARK, NY (US)

(21) Appl. No.: 18/526,045

(22) Filed: Dec. 1, 2023

(51) Int. Cl. G06F 9/50

(52) U.S. Cl. CPC G06F 9/5077; G06F 9/5072

(57) ABSTRACT

Designation of a swap control system in a group of peers within a computing cluster includes determining a processing unit resource capacity for each of a plurality of computing systems in a peer group within a computing cluster, and determining a swap capability for each of the plurality of computing systems. Designation of a swap control system in a group of peers within a computing cluster further includes designating one of the plurality of computing systems as a control system for a swap operation within the peer group based on the processing unit resource capacity and the swap capability of the designated one of the plurality of computing systems relative to the processing unit resource capacity and the swap capability of each of the other computing systems of the plurality of computing systems.

### BACKGROUND

The present disclosure relates to methods, apparatus, and products for designation of a swap control system in a group of peers within a computing cluster.

### SUMMARY

According to embodiments of the present disclosure, various methods, apparatus and products for designation of a control system in a group of peers within a computing cluster are described herein. In some aspects, designation of a swap control system in a group of peers within a computing cluster includes determining a processing unit resource capacity for each of a plurality of computing systems in a peer group within a computing cluster, and determining a swap capability for each of the plurality of computing systems. Designation of a swap control system in a group of peers within a computing cluster further includes designating one of the plurality of computing systems as a control system for a swap operation within the peer group based on the processing unit resource capacity and the swap capability of the designated one of the plurality of computing systems relative to the processing unit resource capacity and the swap capability of each of the other computing systems of the plurality of computing systems.

### BRIEF DESCRIPTION OF THE DRAWINGS

FIG. 1 sets forth an example computing environment according to aspects of the present disclosure.

FIG. 2 sets forth another example computing environment according to aspects of the present disclosure.

FIG. 3 sets forth a flowchart of an example process for swap management address space startup processing according to aspects of the present disclosure.

FIG. 4 sets forth a flowchart of an example process for processing unit capacity change according to aspects of the present disclosure.

FIG. 5 sets forth a flowchart of an example process for update to cross-system coupling facility (XCF) user state processing according to aspects of the present disclosure.

FIG. 6 sets forth a flowchart of an example process for designation of a swap control system in a group of peers within a computing cluster according to aspects of the present disclosure.

FIG. 7 sets forth a flowchart of another example process for designation of a swap control system in a group of peers within a computing cluster according to aspects of the present disclosure.

FIG. 8 sets forth a flowchart of another example process for designation of a swap control system in a group of peers within a computing cluster according to aspects of the present disclosure.

### DETAILED DESCRIPTION

A computing system is often in communication over a network with one or more storage systems for storing and accessing data used during operation of the computing system. The different storage systems are often located in different geographical locations. Each storage system typically includes one or more storage devices (e.g., disk drives) controlled by a storage controller. Storage replication allows for maintaining redundant copies of data on two different storage systems to allow for continuous availability in the event of a failure of one of the storage systems. Switching from usage of one storage system to another storage system is often referred to as a swap event. The switching from one storage system to another storage system in the event of a failure of the storage system is often referred to as an unplanned swap event. An example of an operating system including such swap capability is the HyperSwap function provided by the z/OS operating system offered by International Business Machines™. A sysplex refers to a computing cluster of independent computing systems each having an instance of an operating system. The HyperSwap function provides for continuous availability in the event of disk failures by maintaining synchronous copies of all primary disk volumes on one or more secondary storage controllers. During data replication, data is copied from a source volume to one or more target volumes. The source volume and target volumes that contain copies of the same data are collectively referred to as a copy set. Disk failures can be hidden from applications by the HyperSwap function automatically swapping form one set of disk volumes to another as a result of triggering a swap event.

Peer-to-peer remote copy (PPRC) is a protocol used to replicate a primary storage volume to a secondary storage volume. The primary storage volume and secondary storage volume are often connected together through a communication link called a PPRC path. To facilitate configuration of storage devices, a storage device partitions its possible logical volumes into groups of volumes. Each group of volumes is referred to as a logical subsystem (LSS). An LSS is uniquely identified within the storage system by an LSS identifier that typically is a numerical value. To establish remote mirror and copy pairs, a logical path is established between the associated LSS pair.

Swap functionalities such as provided by HyperSwap designate one of the computing systems in a computing cluster (e.g., a sysplex) as a control system which coordinates swap activities among itself and all other peer computing systems in the computing cluster. The performance of the control system is critical for the overall performance of the entire swap operation. If there is a bottleneck in processing unit (e.g., central processing unit (CPU)) capacity within the control system, the performance of the swap operation for the entire computing cluster is impacted. In existing systems, the control system is selected based on the computer systems ability to participate in a swap operation. For example, if one system has lost fiber connection (FICON) access to PPRC secondary devices but other computing systems in the computing cluster do have access, one of the other computing systems will be designated as the control system. When all conditions are equal, which should be the case under normal operating conditions, the control system is chosen on a “first come first serve” basis. The designation of a control system under these circumstances can lead to undesirable behavior where the control system designation happens to be a low-weighted system in the computing cluster, such as a development system or a test system.

A need exists for designation of a control system for swap operations which allows a computing cluster of peer computing systems to automatically set the optimal swap control system among the computing systems of the computing cluster. The selection of the optimal computing cluster for swap control allows for improved resiliency by providing that the swap operations run on the most capable computing system among the computing systems of the computing cluster, for example, the computing system with the most excess CPU capacity.

Various embodiments provide for a method for designation of a swap control system in a group of peers within a computing cluster. One or more embodiments provide a method of automatically selecting and taking action to designate an optimal computing system of a computing cluster to be the control system for swap operations. In HyperSwap systems, a cross-system coupling facility (XCF) group is used to relate together the computing systems that form a sysplex. An XCF user state for each computing system stores information associated with the computing system and is available to the other computing system members of the XCF group. In an embodiment, when a computing system joins an XCF group used for swap operations, the computing system calculates a processing unit capacity score (e.g., a CPU capacity score) representative of the processing capacity of the computing system, and saves the processing unit capacity score into the User State of the XCF group. The computing system then compares a combination of a swap capability of the computing system and the processing unit capacity score between itself and the current control system. If the computing system is more qualified to be the control system than the current control system, the computing system will attempt to take over as the control system.

One or more embodiments provide for a procedure that takes into account for another lesser-capable computing system attempting to take over as the control system at the same time as the computing system. In an embodiment, if a given system fails to take over as the control system because another computing system already took over, then the computing system will re-evaluate and try again if needed. In another embodiment, when an event occurs that might change the result of the determination of the control system, the determination of the control system is reevaluated under the changed conditions. Trigger events that may change the processing unit capacity score or swap capability of a computing system include, for example: CPUs being brought online or offline to any computing system in the computing cluster; a system in the computing cluster become more or less swap capable than it was before; and a computing system joining or leaving the swap group. In particular embodiments, the determined swap control system is the computing system with the highest CPU capacity score out of the sets of computing systems with the greatest swap capability.

In a particular embodiment, a method of designating a control system in a group of peers within a sysplex includes determining a CPU resource capacity available to each computing system in the sysplex, evaluating and designating an optimal control system based on the swap functional capability combined with the CPU resource capacity of each computing system. In another particular embodiment, counts of online CPUs of each polarization type are used to determine CPU resource capacity. Processor (e.g., CPU) polarization typically refers to a CPU having horizontal polarization or vertical polarization. With horizontal polarization, an underlying hypervisor dispatches each virtual CPU of a logical partition (LPAR) for the same amount of time. For vertical polarization, the hypervisor dispatches certain CPUs for a longer time than others for maximum performance. Typically, there are three types of vertical CPUs: high, medium, and low. Low CPUs receive very little real CPU time while high CPUs receive full real CPU time. Medium CPUs receive real CPU time equivalent to something in between the high CPUs and low CPUs. In a particular embodiment, when designating a control system each computing system has the ability to re-evaluate its functional swap capability and CPU resource capacity as changing events occur.

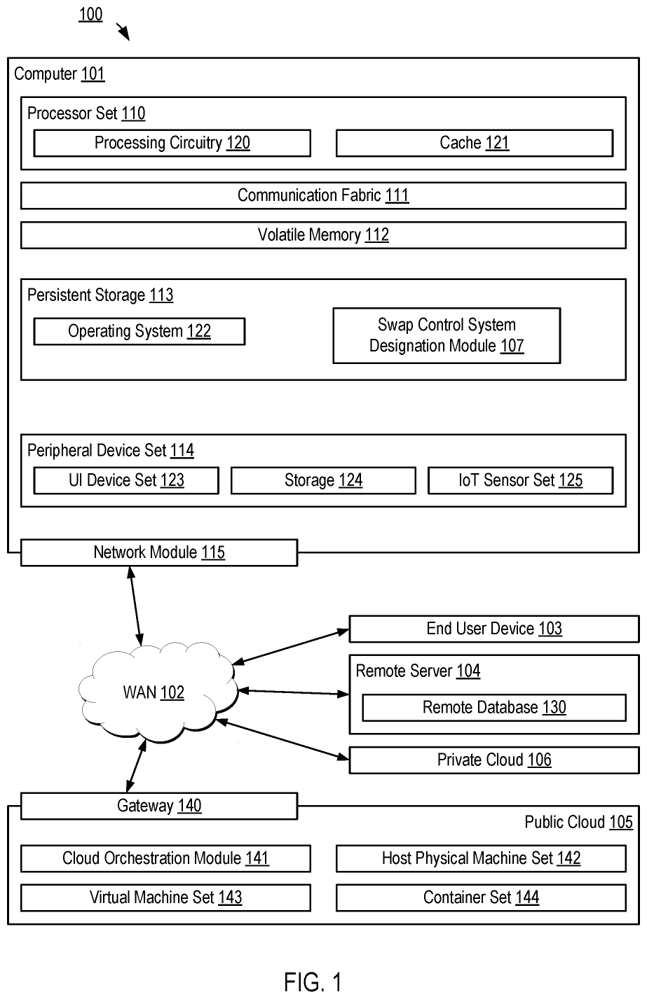

With reference now to FIG. 1, FIG. 1 sets forth an example computing environment according to aspects of the present disclosure. Computing environment 100 contains an example of an environment for the execution of at least some of the computer code involved in performing the various methods described herein, such as swap control system designation module 107. In addition to swap control system designation module 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and swap control system designation module 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Such computer processors as well as graphic processors, accelerators, coprocessors, and the like are sometimes referred to herein as a processing device. A processing device and a memory operatively coupled to the processing device are sometimes referred to herein as an apparatus. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in swap control system designation module 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in swap control system designation module 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

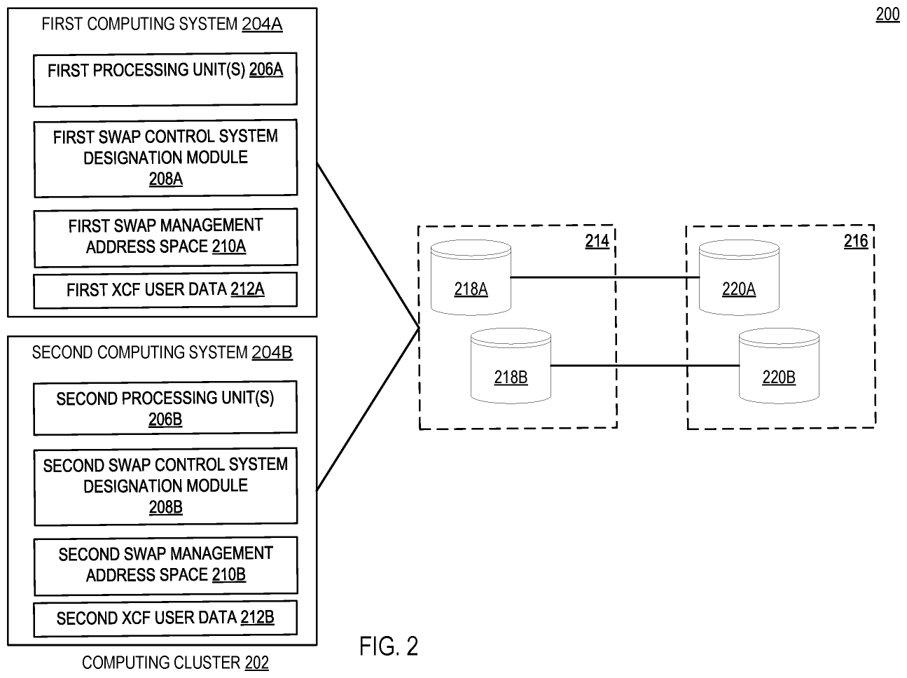

Referring now to FIG. 2, FIG. 2 sets forth another example computing environment according to aspects of the present disclosure. Computing environment 200 includes a computing cluster 202 formed of a first computing system 204A and a second computing system 204B. The first computing system 204A includes one or more first processing units 206A, a first swap control system designation module 208A, a first swap management address space 210A, and first XCF user data 212A. Similarly, the second computing system 204B includes one or more second processing units 206B, a second swap control system designation module 208B, a second swap management address space 210B, and second XCF user data 212B.

In a particular embodiment, the one or more first processing units 206A and the one or more second processing units 206B are CPUs. In other embodiments, the one or more first processing units 206A and the one or more second processing units 206B are any other type of processing device such as a graphical processing unit (GPU) or application-specific integrated circuit (ASIC). In a particular embodiment, the first swap control system designation module 208A and the second swap control system designation module 208B includes the swap control system designation module 107 described with respect to FIG. 1.

The first swap management address space 210A stores system information about the first computing system 204A including information about the one or more first processing units 206A and their respective polarizations as well as a swap capability of the first computing system 204A. Similarly, the second swap management address space 210B stores system information about the second computing system 204B including information about the one or more second processing units 206B and their respective polarizations as well as a swap capability of the second computing system 204B. In a particular embodiment, the first swap management address space 210A and the second swap management address space 210B are HyperSwap Management Adress Spaces (IOSHMCTLs). The first XCF user data 212A includes a processing unit capacity score (e.g., a CPU capacity score) calculated for the one or more first processing units 206A. Similarly, the second XCF user data 212B includes a processing unit capacity score (e.g., a CPU capacity score) calculated for the one or more second processing units 206B.

The first computing system 204A and the second computing system 204B are each in communication with a set of source storage devices (or volumes) 214. In a particular embodiment, each of first computing system 204A and the second computing system 204B are in communication with the set of source storage devices 214 via FICON connections. The set of source storage devices 214 are in communication with a set of target storage devices (or volumes) 216. In a particular embodiment, the set of source storage devices 214 are in communication with the set of target storage devices 216 via PPRC connections. In a particular embodiment, the set of source storage devices 214 and the set of target storage devices 216 are located at a different location or site. In one or more embodiments, each of the set of source storage devices 214 and the set of target storage devices 216 include one or more associated storage controllers (not shown). The set of source storage devices 214 includes source storage device 218A and source storage device 218B. The set of target storage devices 216 includes target storage device 220A and target storage device 220B. Although various embodiments are illustrated using two computing system for simplicity of explanation, in other embodiments more than two computing systems are used.

In an example operation, the first computing system 204A calculates a processing unit capacity score for the one or more first processing units 206A and stores the processing unit capacity score in the first XCF user data 212A. Similarly, the second computing system 204B calculates a processing unit capacity score for the one or more second processing units 206B and stores the processing unit capacity score in the second XCF user data 212B. One of the first computing system 204A and the second computing system 204B is designated as the control system for swap operations based on their relative processing unit capacity scores and swap capabilities. In the example, the first computing system 204A is designated as the control system for swap operations for the computing cluster 202. Upon occurrence of a swap event in which the first computing system 204A and the second computing system 204B are to swap from usage of the set of source storage devices 214 to usage of the set of target storage devices 216, the first computing system 204A functions as the control system for the swap operations. Upon occurrence of a triggering event that may impact one or more of the processing unit capacity scores and swap capabilities of the first computing system 204A and the second computing system 204B, the processing unit capacity scores and swap capabilities may be reevaluated, and a different one of the first computing system 204A and the second computing system 204B may be designated as the control system based on results of the reevaluation.

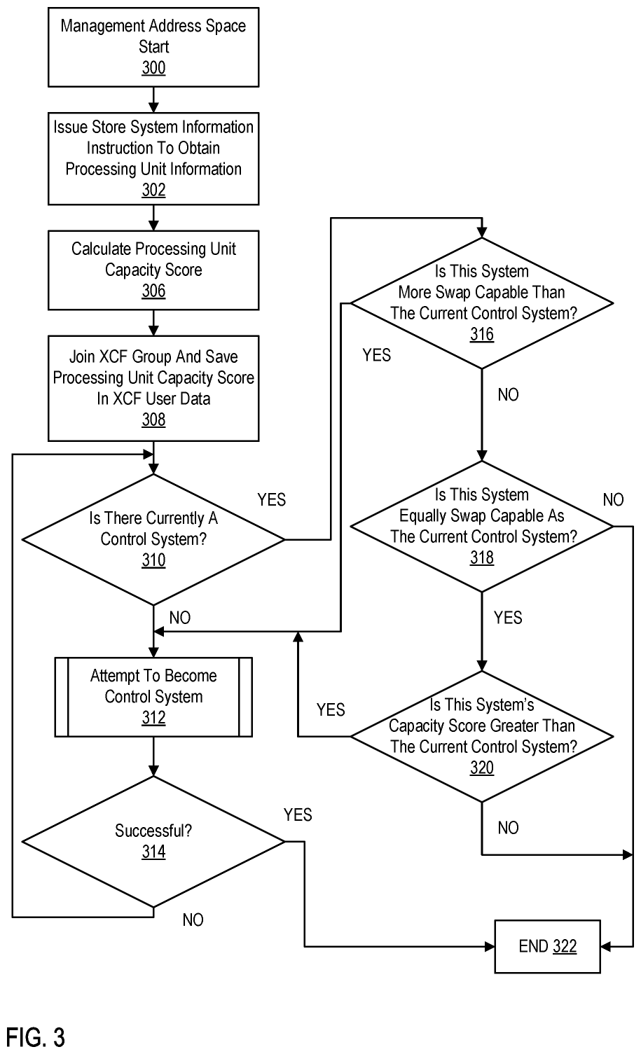

Referring now to FIG. 3, FIG. 3 sets forth a flowchart of an example process for swap management address space startup processing according to aspects of the present disclosure. On a particular computing system, a management address space is started 300. In a particular embodiment, the management address space is a HyperSwap Management Address Space (ISOSHMCTL). After the computing system has started task initialization and built its main control blocks, the computing system issues 302 a store system information instruction to obtain information about the processing units (e.g., CPUs) of the computing system. In a particular embodiment, the store system information instruction is a zArchitecture STORE SYTEM INFORMATION instruction. The information includes the processing units available to the computing system and their respective polarizations. From a user perspective, the polarization of the processing units is an effect of an LPAR weight that is assigned to a computing system. An LPAR with a greater weight in comparison to the other computing systems will have greater entitlement to processor resources, which surfaces with, for example, vertical high CPUs.

The computing system calculates 306 a processing unit capacity score (e.g., a CPU capacity score) which represents how many processing unit resources the computing system has. The processing unit capacity score is used comparatively with other computing systems. An example CPU capacity score calculation is as follows:

CPU capacity score=h+0.5*m+0.1*l where h is the count of vertical high CPUs, m is the count of vertical medium CPUs, and/is the count of vertical low CPUs.

The CPU capacity score is representative of a sum of the count of CPUs weighted by the polarity type. In an alternative embodiment, an actual count of CPUs or some other set of values representing relative CPU capacity is used instead of the CPU capacity score to determine a CPU capacity of the computing system.

The computing system joins 308 the XCF group of the computing cluster, and saves the processing unit capacity score in the XCF user data for this computing system's member in the swap group. After the computing system has joined the XCF group, the computing system performs logic to determine if it should become the new swap control system. The computing system first determines 310 if there is currently another control system. If there is not currently another control system, the computing system attempts 312 to become the control system. The computing system determines 314 if the attempt to become the control system was successful. If the computing system is not successful in its attempt to become the control system, the process returns to determine 310 if there is currently a control system. If the computing system is successful in its attempt to become the control system, the process ends 322.

If the computing system determines that there is already a control system, the computing system checks to determine if it should take over and become the new control system. The computing system compares the current swap capability between the computing system and the current control system. In one or more embodiments, swap capability refers to a swap enablement/disablement status (e.g., HyperSwap Enablement/Disablement) of the computing system. For example, if the current control system has lost FICON access to its PPRC secondary devices but this computing system has not and this computing system has no other disablement reasons, then this computing system is said to be more swap capable than the current control system. The computing system determines 316 whether it is more swap capable than the current control system. If the computing system is more swap capable than the current control system, the computing system returns and attempts 312 to become the control system.

If the computing system is not more swap capable than the current control system, the computing system determines 318 if it is equally swap capable as the current control system. If the computing system is not equally swap capable as the current control system, the process ends 322. If the system is equally swap capable as the current control system, then a processing unit comparison takes place. The computing system determines 320 if this system's processing unit capacity score is greater than the processing unit capacity score of the control system. In a particular embodiment, the comparison is performed by looking at the computing systems XCF user state information compared to the control system's user state information. If the computing system has a greater processing unit capacity score, the computing system attempts 312 to become the control system. If the computing system processing unit capacity score is not greater than the current control system, the process ends 322.

In a particular embodiment, the attempt 312 to become the control system is performed using compare and swap type logic in which the attempt will be successful as long as no other computing system took over as the new control system while this processing was occurring. If another computing system did take over as the new control system, then this computing system's attempt to become the control system would not have been successful. In that case, the computing system reevaluates itself compared to the new control system.

The end result is that the swap control system will be the system with the highest processing unit capacity score (e.g., CPU capacity score) out of the set of computing systems with the greatest swap (e.g., HyperSwap) capability.

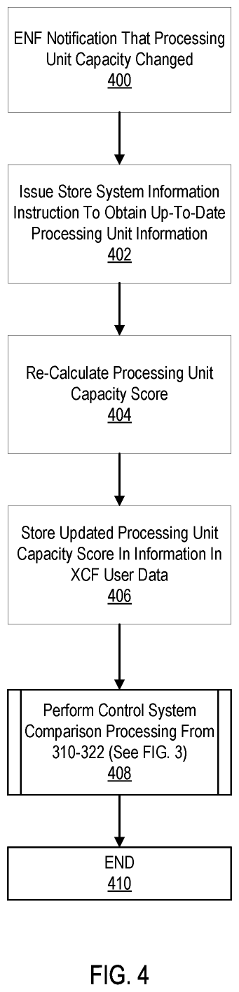

Referring now to FIG. 4, FIG. 4 sets forth a flowchart of an example process for processing unit capacity change according to aspects of the present disclosure. FIG. 4 shows processing when processing unit capacity changes. Swap code on each computing system will use an Event Notification Listener (ENF) to get notified 400 when processing unit capacity changes. The listener exit signals a task used from control system takeover logic to reevaluate the comparison of processing unit capacity and swap capability between computing systems. The computing system issues 402 another store system information instruction to obtain up-to-date processing unit information including processing unit capacity information. The computing system re-calculates 404 the processing unit capacity score, and stores 406 the updated processing unit capacity score in information in the XCF user data. The computer system then performs 408 the same control system comparison processing as discussed with respect to steps 310-322 of the management address space startup described with respect to FIG. 3. The example process ends 410.

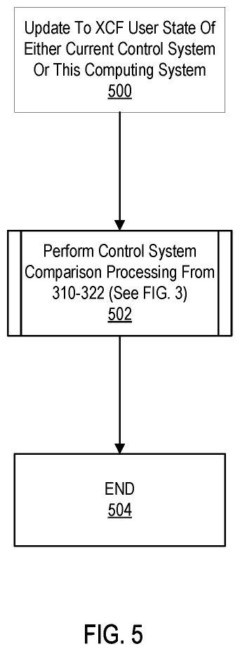

Referring now to FIG. 5, FIG. 5 sets forth a flowchart of an example process for update to XCF user state processing according to aspects of the present disclosure. If there is an update to either the processing unit capacity on the control system, or to the swap enablement/disablement status on either the current control system or this computing system, this computing system detects an event for an update 500 to the XCF user state of either the current control system or this computing system. The computer system then performs 502 the same control system comparison processing as discussed with respect to steps 310-322 of the management address space startup described with respect to FIG. 3. The process then ends 504.

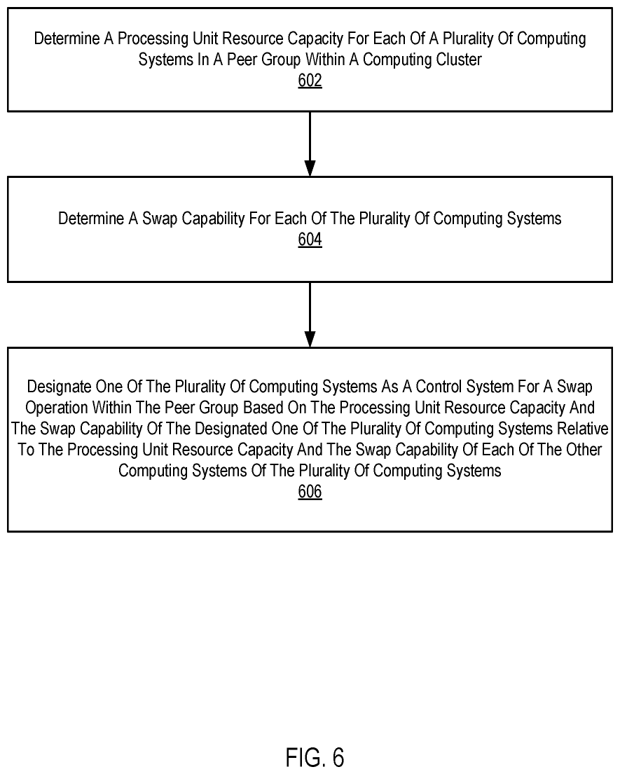

Referring now to FIG. 6, FIG. 6 sets forth a flowchart of an example process for designation of a swap control system in a group of peers within a computing cluster according to aspects of the present disclosure. The example process includes determining 602 a processing unit resource capacity for each of a plurality of computing systems in a peer group within a computing cluster. In a particular embodiment, wherein the processing unit resource capacity comprises a central processing unit (CPU) resource capacity.

The example process further includes determining 604 a swap capability for each of the plurality of computing systems. In a particular embodiment, determining the swap capability for each of the plurality of computing systems further includes determining a swap capability measure for each of the plurality of computing systems. In a particular embodiment, the swap capability measure for a particular computing system of the plurality of computing systems is based on an availability of the particular computing system to participate in the swap operation.

The example process further includes designating 606 one of the plurality of computing systems as a control system for a swap operation within the peer group based on the processing unit resource capacity and the swap capability of the designated one of the plurality of computing systems relative to the processing unit resource capacity and the swap capability of each of the other computing systems of the plurality of computing systems.

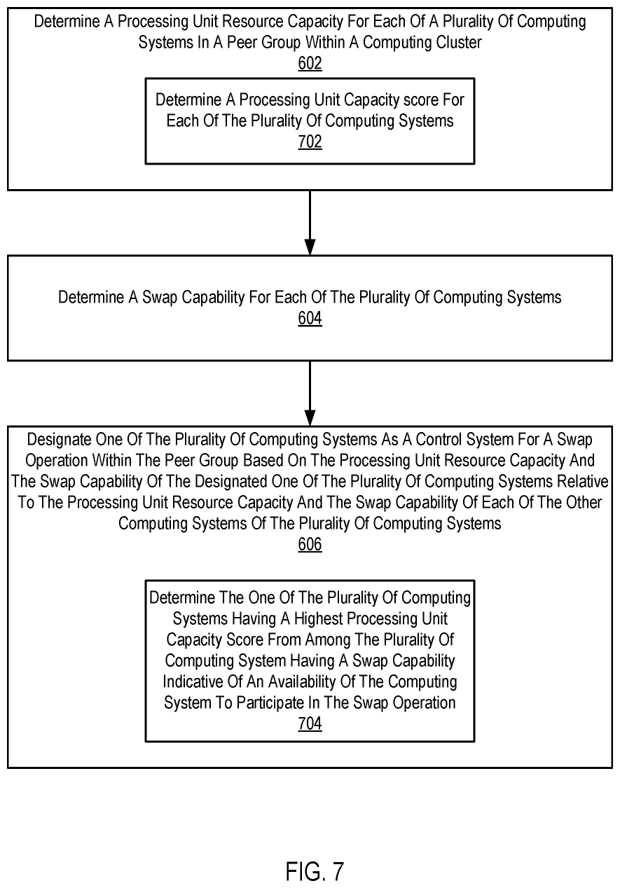

Referring now to FIG. 7, FIG. 7 sets forth a flowchart of another example process for designation of a swap control system in a group of peers within a computing cluster according to aspects of the present disclosure. The process of FIG. 7 is similar to the process described with respect to FIG. 6 and further includes wherein determining 602 the processing unit resource capacity for each of the plurality of computing systems further includes determining 702 a processing unit capacity score for each of the plurality of computing systems. In a particular embodiment, the processing unit resource capacity score for a particular computing system of the plurality of computing systems is based on one or more of a number of online processing units of the particular computing system, a computational capability of each of the online processing units of the particular computing system, and a polarization of each of the online processing unit of the particular computing system.

The process of FIG. 7 further includes wherein designating 606 the one of the of the plurality of computing systems as the control system for the swap operation further includes determining 704 the one of the plurality of computing systems having a highest processing unit capacity score from among the plurality of computing system having a swap capability indicative of an availability of the computing system to participate in the swap operation.

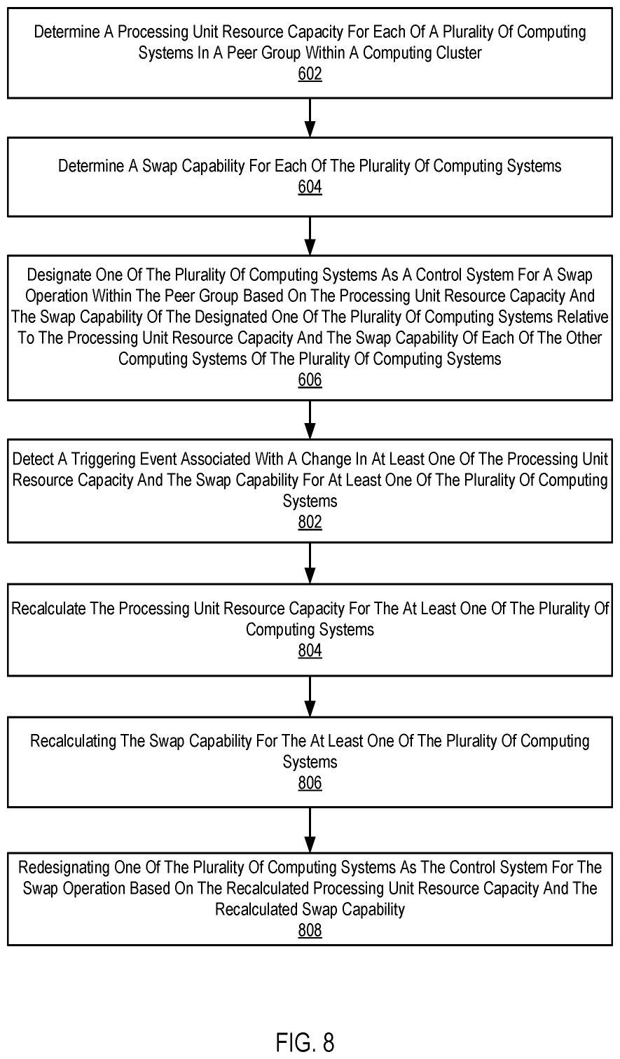

Referring now to FIG. 8, FIG. 8 sets forth a flowchart of another example process for designation of a swap control system in a group of peers within a computing cluster according to aspects of the present disclosure. The process of FIG. 8 is similar to the process described with respect to FIG. 6 and further includes detecting 802 a triggering event associated with a change in at least one of the processing unit resource capacity and the swap capability for at least one of the plurality of computing systems. The process of FIG. 8 further includes recalculating 804 the processing unit resource capacity for the at least one of the plurality of computing systems, and recalculating 806 the swap capability for the at least one of the plurality of computing systems. The process of FIG. 8 further includes redesignating 808 one of the plurality of computing systems as the control system for the swap operation based on the recalculated processing unit resource capacity and the recalculated swap capability.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
determining a processing unit resource capacity for each of a plurality of computing systems in a peer group within a computing cluster;
determining a swap capability for each of the plurality of computing systems; and
designating one of the plurality of computing systems as a control system for a swap operation within the peer group based on the processing unit resource capacity and the swap capability of the designated one of the plurality of computing systems relative to the processing unit resource capacity and the swap capability of each of the other computing systems of the plurality of computing systems.

2. The method of claim 1, wherein determining the processing unit resource capacity for each of the plurality of computing systems further comprises determining a processing unit capacity score for each of the plurality of computing systems.

3. The method of claim 2, wherein designating the one of the of the plurality of computing systems as the control system for the swap operation further comprises determining the one of the plurality of computing systems having a highest processing unit capacity score from among the plurality of computing system having a swap capability indicative of an availability of the computing system to participate in the swap operation.

4. The method of claim 2, wherein the processing unit resource capacity score for a particular computing system of the plurality of computing systems is based on one or more of a number of online processing units of the particular computing system, a computational capability of each of the online processing units of the particular computing system, and a polarization of each of the online processing unit of the particular computing system.

5. The method of claim 1, wherein determining the swap capability for each of the plurality of computing systems further comprises determining a swap capability measure for each of the plurality of computing systems.

6. The method of claim 5, wherein the swap capability measure for a particular computing system of the plurality of computing systems is based on an availability of the particular computing system to participate in the swap operation.

7. The method of claim 1, further comprising:
detecting a triggering event associated with a change in at least one of the processing unit resource capacity and the swap capability for at least one of the plurality of computing systems;
recalculating the processing unit resource capacity for the at least one of the plurality of computing systems;
recalculating the swap capability for the at least one of the plurality of computing systems; and
redesignating one of the plurality of computing systems as the control system for the swap operation based on the recalculated processing unit resource capacity and the recalculated swap capability.

8. The method of claim 1, wherein the processing unit resource capacity comprises a central processing unit (CPU) resource capacity.

9. An apparatus comprising:
a processing device; and
memory operatively coupled to the processing device, wherein the memory stores computer program instructions that, when executed, cause the processing device to:
determine a processing unit resource capacity for each of a plurality of computing systems in a peer group within a computing cluster;
determine a swap capability for each of the plurality of computing systems; and
designate one of the plurality of computing systems as a control system for a swap operation within the peer group based on the processing unit resource capacity and the swap capability of the designated one of the plurality of computing systems relative to the processing unit resource capacity and the swap capability of each of the other computing systems of the plurality of computing systems.

10. The apparatus of claim 9, wherein the computer program instructions to cause the processing device to determine the processing unit resource capacity for each of the plurality of computing systems further includes computer program instructions that, when executed, cause the processing device to determine a processing unit capacity score for each of the plurality of computing systems.

11. The apparatus of claim 10, wherein the computer program instructions to cause the processing device to designate the one of the of the plurality of computing systems as the control system for the swap operation further includes computer program instructions that, when executed, cause the processing device to determine the one of the plurality of computing systems having a highest processing unit capacity score from among the plurality of computing system having a swap capability indicative of an availability of the computing system to participate in the swap operation.

12. The apparatus of claim 10, wherein the processing unit resource capacity score for a particular computing system of the plurality of computing systems is based on one or more of a number of online processing units of the particular computing system, a computational capability of each of the online processing units of the particular computing system, and a polarization of each of the online processing unit of the particular computing system.

13. The apparatus of claim 9, wherein the computer program instructions to cause the processing device to determine the swap capability for each of the plurality of computing systems further comprises includes computer program instructions that, when executed, cause the processing device to determine a swap capability measure for each of the plurality of computing systems.

14. The apparatus of claim 13, wherein the swap capability measure for a particular computing system of the plurality of computing systems is based on an availability of the particular computing system to participate in the swap operation.

15. The apparatus of claim 9, wherein the computer program instructions, when executed, cause the processing device to:
detect a triggering event associated with a change in at least one of the processing unit resource capacity and the swap capability for at least one of the plurality of computing systems;
recalculate the processing unit resource capacity for the at least one of the plurality of computing systems;
recalculate the swap capability for the at least one of the plurality of computing systems; and
redesignate one of the plurality of computing systems as the control system for the swap operation based on the recalculated processing unit resource capacity and the recalculated swap capability.

16. The apparatus of claim 9, wherein the processing unit resource capacity comprises a central processing unit (CPU) resource capacity.

17. A computer program product comprising a computer readable storage medium, wherein the computer readable storage medium comprises computer program instructions that, when executed:
determine a processing unit resource capacity for each of a plurality of computing systems in a peer group within a computing cluster;
determine a swap capability for each of the plurality of computing systems; and
designate one of the plurality of computing systems as a control system for a swap operation within the peer group based on the processing unit resource capacity and the swap capability of the designated one of the plurality of computing systems relative to the processing unit resource capacity and the swap capability of each of the other computing systems of the plurality of computing systems.

18. The computer program product of claim 17, wherein the computer program instructions, to determine the processing unit resource capacity for each of the plurality of computing systems further includes computer program instructions that, when executed, determine a processing unit capacity score for each of the plurality of computing systems.

19. The computer program product of claim 18, wherein the computer program instructions to designate the one of the of the plurality of computing systems as the control system for the swap operation further include computer program instructions that, when executed, determine the one of the plurality of computing systems having a highest processing unit capacity score from among the plurality of computing system having a swap capability indicative of an availability of the computing system to participate in the swap operation.

20. The computer program product of claim 17, further comprising computer program instructions to:
detect a triggering event associated with a change in at least one of the processing unit resource capacity and the swap capability for at least one of the plurality of computing systems;
recalculate the processing unit resource capacity for the at least one of the plurality of computing systems;
recalculate the swap capability for the at least one of the plurality of computing systems; and
redesignate one of the plurality of computing systems as the control system for the swap operation based on the recalculated processing unit resource capacity and the recalculated swap capability.
